(19) United States
(12) Patent Application Publication
(10) Pub. No.: US 2002/0098826 A1
(43) Pub. Date: Jul. 25, 2002

(54) Wireless payphone system and charging method

(75) Inventors: Georges Wakil, Cairo (EG); Richard Brunner, Bromma (SE)

Correspondence Address: ERICSSON RESEARCH CANADA, 8400 DECARIE BLVD., MONTREAL, QC, H4P 2N2, CA

(73) Assignee: Telefonaktiebolaget LM Ericsson (publ)

(21) Appl. No.: 09/770,218

(22) Filed: Jan. 25, 2001

(51) Int. Cl. H04M 11/00

(52) U.S. Cl. 455/406; 455/409; 455/405

(57) ABSTRACT

A conventional wireline payphone is connected to an external wireless interface device through a telephone line. The external wireless interface device operates as an interface between a selected digital wireless cellular air interface and the telephone line connection to the wireline payphone. Communication is established over the digital air interface to allow the serving network to collect calling information relating to a payphone user's call request. This information is processed centrally in the cellular network to determine whether the user is financially authorized to engage in the requested call. If so, call handling information relating to an authorized time duration for the call is supplied to a serving switch that then controls further handling, and if necessary termination, of that call in accordance with that information.

### BACKGROUND OF THE INVENTION

1. Technical Field of the Invention

The present invention relates to wireless payphones (also referred to as paystations) having access to a digital cellular air interface and, in particular, to a wireless payphone system and charging method wherein the monetary charge for payphone use is determined in the supporting telecommunications network rather than at the payphone itself.

2. Description of Related Art

Wireless payphone systems are well known in the art. One common system utilizes conventional analog cellular telephone technology (AMPS) integrated within the payphone device itself to communicate over an analog cellular air interface with a supporting cellular communications system. These analog wireless payphones include card (credit, debit, and calling) reading technology to allow users a convenient way to pay for phone use. The phones further include intelligence (generally in form of a microprocessor controller) to determine the appropriate charging rate for the call and to manage the accounting functions with respect to debiting or charging for that call.

The analog wireless payphones operate and behave much like an analog wireless mobile station with the exception that the supporting communications network sends towards the wireless payphone a special message (i.e., the answer signal) that indicates when the called party has answered the phone. Responsive to this message, the wireless payphone itself starts charging (or calculating the charge) for the call. In most situations, the charging rates for the call are based on the relative locations of the payphone and the terminal associated with the called number (distance) in combination with the current time of day at the calling location. The algorithm that accounts for distance and time of day in calculating the rate and total charge for a call is kept and executed within the wireless payphone itself. When the call ends, the payphone determines the length of the call and uses the algorithm, in view of the distance and time of day factors, to calculate a total charge which is then billed to or debited from the caller's account.

There are a number of recognized disadvantages to this conventional wireless payphone system and charging method, including: (a) the wireless payphone must have a substantial amount of intelligence beyond simple call handling and particularly in terms of storing and sorting the charging rates (i.e., manipulating the algorithm and its variables) and further in terms of detecting and processing the answer signal when received over the air interface; (b) because charge is calculated in the payphone itself, any changes in the applicable rate structure (i.e., algorithm changes) must be deployed in each and every payphone; (c) a wireless service provider is dependent on the wireless payphone manufacturer for equipment (which can be quite expensive due to the increased intelligence and special hardware needed); and, (d) wireless payphone manufacturers have been slow to evolve to the latest digital wireless cellular technologies (D-AMPS, GSM, PCS, CDMA, and the like) and thus the existing analog wireless payphones cannot provide the best communications quality and fail to most efficiently utilize the expensive allocated frequency spectrum.

There is accordingly a need for an improved wireless payphone system and charging method. Preferably, this improved system should allow for use of conventional (wireline) payphone devices so that service operators need not be dependent on the use of expensive custom integrated wireless payphone devices. Furthermore, the improved system should allow for wireless operation with the use of digital air interface communications technologies (such as D-AMPS, GSM, PCS, CDMA, and the like). Additionally, charge determination should be made in the serving telecommunications network rather than in the wireless payphone itself.

### SUMMARY OF THE INVENTION

A wireless payphone includes a conventional wireline payphone connected to an external wireless interface device through a telephone line. The external wireless interface device is operable to interface between a selected one or ones of the digital wireless cellular air interfaces (like D-AMPS, GSM, PCS or CDMA) and the telephone line. The telephone line may comprise either an analog twisted pair telephone line or a digital subscriber line. This wireless payphone configuration advantageously obviates the need for use of specially manufactured wireless payphone devices and provides access to better quality communications resources provided by the digital air interface wireless cellular network.

A wireless payphone system includes a user side having the wireless payphone as described above, and a network side having a conventional cellular network infrastructure augmented by a prepaid service system adapted to support payphone operation. The prepaid service system operates to collect, through the cellular network, calling information relating to a payphone user's call request, determine whether the user is financially authorized to engage in the requested call, and supply information used by a serving switch to control handling of that call in accordance with the determined financial authorization. In this way, charging for the call is advantageously calculated on the network side rather than the user side.

The present invention further comprises a method for supporting network based charging for use of a wireless payphone.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1 is a network diagram for the wireless payphone system of the present invention; and

FIG. 2 is a signal flow and network operation diagram illustrating the provision of wireless payphone service in the context of the FIG. 1 system.

### DETAILED DESCRIPTION OF THE DRAWINGS

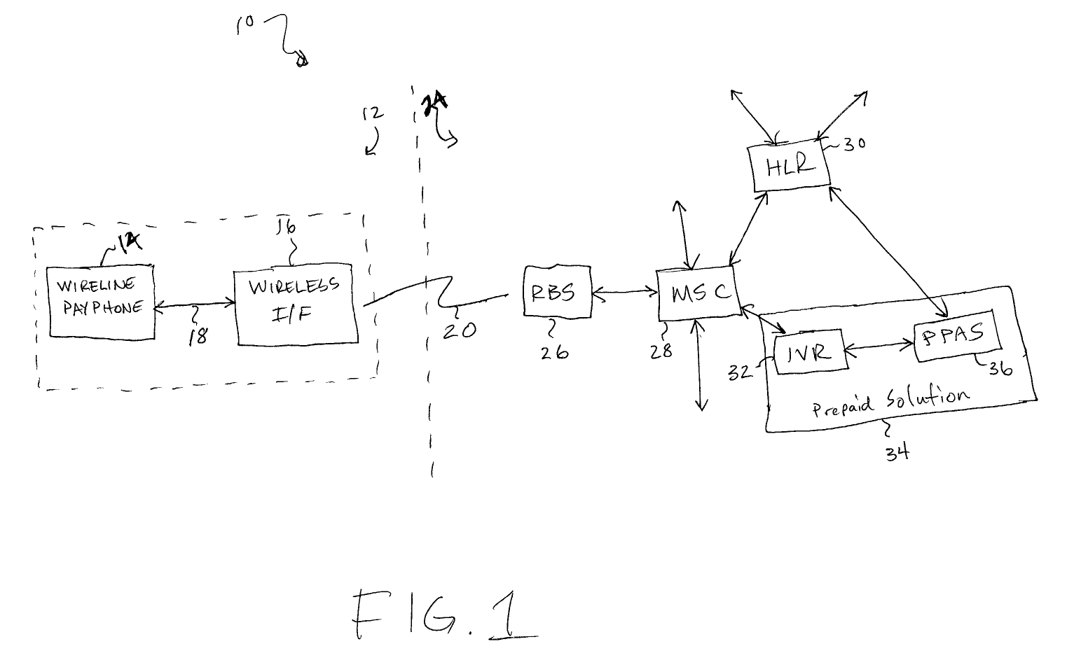

Reference is now made to FIG. 1 wherein there is shown a network diagram for the wireless payphone system 10 of the present invention. The system includes, on a user side 12, a conventional wireline payphone device 14 like that commonly used by wireline service operators to offer pay-per-use telecommunications service in public places. The user side 12 further includes an external wireless interface device 16 connected to the wireline payphone device 14 via a telephone line 18. The external wireless interface device 16 is preferably not integrated within the conventional wireline payphone device 14 in order to maximize flexibility of the design and permit basic use of conventional wireline payphones (illustrated in FIG. 1 with the solid line configuration). As an alternative, the external wireless interface device 16 may be placed within the housing of the conventional wireline payphone device 14 and connected through the line 18 (illustrated in FIG. 1 with the dotted line configuration) but is otherwise not integrated in an electrical or mechanical fashion with the payphone itself.

The wireless interface device 16 may comprise any commonly available device that operates to interface between the wireless cellular air interface 20 and at least one telephone line 18. In a preferred embodiment, the wireless interface device 16 may comprise a Single Line Terminal (SLT) or Fixed Cellular Terminal (FCT) device like that manufactured and sold by Ericsson and operable to interface between a selected one or ones of the digital wireless cellular air interfaces (like D-AMPS, GSM, PCS or CDMA) 20 and an analog twisted pair telephone line 18. In this preferred implementation, the wireline payphone device 14 comprises a conventional plain old telephone service (POTS) payphone. In an alternative embodiment, the wireless interface device 16 may comprise a Multi Line Terminal (MLT) device like that manufactured and sold by Ericsson and operable to interface between a selected one or ones of the digital wireless cellular air interfaces (like D-AMPS, GSM, PCS or CDMA) 20 and a plurality of analog twisted pair telephone lines 18 (each of which may be connected to a separate payphone device 14 to form a phone bank for use in crowded public places). In this implementation, the wireline payphone device 14 similarly comprises a conventional plain old telephone service (POTS) payphone. Notwithstanding the foregoing, however, it is recognized that the wireless interface device 16 may instead comprise any selected device (including modifications to the SLT, FCT and MLT technologies) that operates to interface between a selected one or ones of the digital wireless cellular air interfaces (like D-AMPS, GSM, PCS or CDMA.) 20 and one or more digital telephone lines 18 (similar in nature and operation to the subscriber lines provided through a PBX). In this alternative implementation, the wireline payphone device 14 would instead comprise a digital wireline payphone. It is further recognized that, although not preferred, the wireless interface device 16 may instead comprise any selected device that operates to interface between an analog wireless cellular air interface (like AMPS) 20 and one or more telephone lines 18 (either analog twisted pair or digital subscriber line). Each of the foregoing potential implementations may be advantageously used in connection with a network side charging operation as discussed below.

On a network side 24 of the system 10, a radio base station (RBS) 26 communicates with the wireless interface 16 (user side) over the air interface 20. The base station 26 is connected in a well known manner to a mobile switching center 28 (only one of many shown in order to simplify the drawing). The mobile switching center 28 is connected via ANSI-41 (or any other network signaling standard) signaling links to a home location register (HLR) 30. This collection of network components operates in a well known manner to provide wireless cellular voice and data calling services to subscribers. Accordingly, a more detailed description of network operation is provided herein only with respect to the wireless payphone operation of the present invention.

The mobile switching center 28 is further connected via ISUP trunks to an interactive voice response (IVR) center 32. The interactive voice response center 32 comprises one component of a wireless prepaid solution (PPS) system 34 manufactured and supplied by Ericsson. The system 34 further includes a pre-paid administration system (PPAS) node 36 that is connected via a TCP/IP connection to the interactive voice response center 32, and via ANSI-41 (or any other network signaling standard) signaling links to the home location register 30. Operation of the prepaid solution system to provide prepaid wireless cellular voice and data calling services to subscribers is well known to those skilled in the art. Accordingly, a more detailed description of prepaid solution system operation is provided herein only with respect to the wireless payphone operation of the present invention.

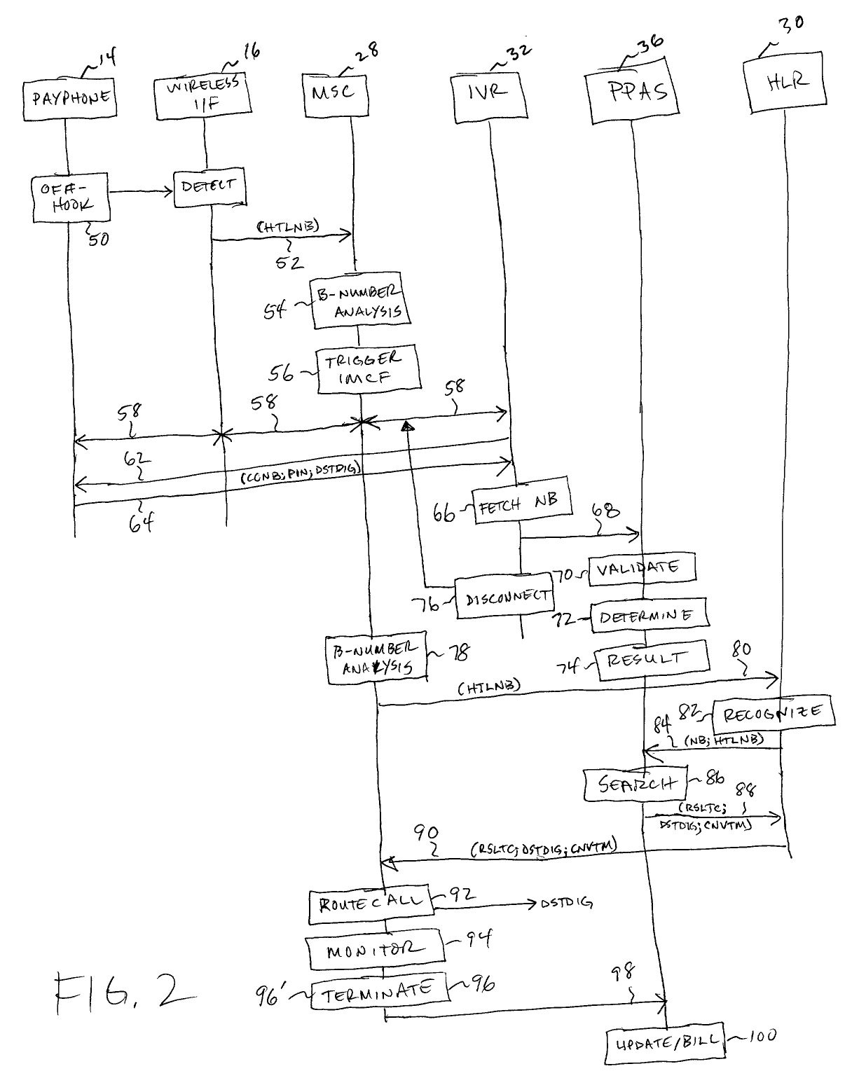

Reference is now additionally made to FIG. 2 wherein there is shown a signal flow and network operation diagram illustrating the provision of wireless payphone service in the context of the FIG. 1 system. The wireless interface device 16 is defined within the home location register 30 as a normal cellular subscriber. In this regard, it has a defined subscription and an assigned telephone number (NB) much like any other mobile station. The home location register 30 is further programmed with the identification of a hotline number (HTLNB) which identifies a generic prepaid subscriber (i.e., a cellular subscription) with a special prepaid category indicating that the HTLNB is to be used for wireless payphones. This hotline number is programmed into the wireless interface device 16. Responsive to a user taking the wireline payphone device 14 handset off-hook (step 50), the wireless interface device 16 detects this event and responds thereto by retrieving the programmed HTLNB and sending (step 52) it over the air interface 20 towards the radio base station 26 and mobile switching center 28. In this step 52 operation, the HTLNB comprises the called number digits as contained within a conventional wireless call origination message sent over the air interface 20.

The mobile switching center 28 performs conventional B-number analysis (step 54) on the called number digits that were sent in step 52. The mobile switching center 28 is programmed with the HTLNB in its B-number analysis table to trigger (step 56) execution of an incoming message coordination feature (IMCF) which, generally speaking, causes an announcement to be played to the user before the mobile switching center 28 completes the B-number analysis and pre-routes to the called number (i.e., to the HTLNB). The wireline payphone device 14 is accordingly voice channel connected (step 58), with respect to provision of the incoming message coordination feature, to the interactive voice response center 32 over the air interface 20 and through the wireless interface device 16, radio base station 26 and mobile switching center 28.

The interactive voice response center 32 then engages in an interactive transaction (step 60) where the user of the wireline payphone device 14 is voice message prompted (steps 62) to enter (steps 64) a credit or calling card number (CCNB), personal identification number (PIN) code, and destination digits (DSTDIG) for the outgoing call from the payphone. The interactive voice response center 32 further fetches (step 66) from the ISUP trunks carrying the call connection the identification of the calling party (which in this case is the wireless interface device 16 number (NB)). The interactive voice response center 32 collected information (NB, CCNB, PIN and DSTDIG) is then forwarded (step 68) to the pre-paid administration system (PPAS) node 36 via the TCP/IP connection interface.

The pre-paid administration system node 36 then validates (step 70) the CCNB and PIN against each other and determines (step 72) a maximum conversation time (CNVTM) permitted for the user in accordance with that validation. This determined maximum conversation time may be based on a remaining balance with respect to an established prepaid telecommunications service account identified by the CCNB, protected by the PIN, and maintained with respect to that user. Alternatively, it may comprise a maximum time determined from maximum pre-authorized credit card charge amount (which, in essence, becomes an established prepaid service balance for the current call). In any event, the determination in step 72 takes into account conventional charging factors that affect charging rate determination including time of day and distance (based on the collected DSTDIG information). A result code (RSLTC) is then generated (step 74) based on that step 72 determination, wherein the code indicates whether the pre-paid administration system node 36 has authorized continuing with call setup from a certain wireless interface device 16 number (NB) to a certain destination (DSTDIG) for a certain amount of time (CNVTM).

In the meantime, the interactive voice response center 32 has completed its business with the user and disconnects (step 76) itself from the call. This occurrence is detected by the mobile switching center 28 which responds by triggering continuation of incoming message coordination feature execution. Continued B-number analysis of the dialed HTLNB is performed (step 78) causing the mobile switching center 28 to contact (step 80) the home location register 30 associated with the HTLNB (using, for example, a location request message (LOCREQ), or the like, containing the dialed HTLNB) to pre-route the call origination. The home location register 30 recognizes (step 82) that the HTLNB is defined as a special wireless payphone prepaid subscriber (i.e., it is not the called party number) and accordingly queries (step 84) the pre-paid administration system node 36 with the calling party number (NB) and the dialed number (HTLNB) in a special query message relating to wireless payphone operation. A proprietary extension to the ANSI-41 (or any other network signaling standard) specification may be implemented to support operation of the present invention with respect to the message communications sent in steps 80 and 84.

The pre-paid administration system node 36 receives the home location register query and searches (step 86) its records to determine whether it has previously generated a result code (RSLTC) with respect to the query identified wireless interface device 16 number (NB) (see, steps 72 and 74 as discussed above). Assuming that such a result code was generated, and further that the result code indicates that the pre-paid administration system node 36 has authorized continuing with call setup, the determined result code (RSLTC), destination digits for the call (DSTDIG for the called party) and the authorized conversation time (CNVTM) information are returned (step 88) to the home location register 30 in a query return result message. This information is then passed on (step 90) to the mobile switching center 28 (using, for example, a location request return result message (locreq), or the like, containing the RSLTC, DSTDIG and CNVTM information). Again, a proprietary extension to the ANSI-41 (or any other network signaling standard) specification may be implemented to support operation of the present invention with respect to the message communications sent in steps 88 and 90.

Using the received destination digit information, the mobile switching center routes/through connects (step 92) the originated call to the user specified destination. Elapsed conversation time for the through connected call is monitored (step 94) in comparison to the maximum conversation time (CNVTM) permitted for the user. If the elapsed call time exceeds the specified maximum time, the call is terminated in step 96. If, on the other hand, the call is terminated (step 96′) by the user prior to expiration of the specified maximum time, the actual elapsed time for the call is sent (step 98) from the mobile switching center 28 to the pre-paid administration system node 36 through the home location register 30. The pre-paid administration system node 36 then updates stored prepaid balance (or arranges for billing, all generally step 100) with respect to the user and the completed call.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A wireless payphone, comprising:
a conventional wireline payphone; and
a wireless interface device connected to the conventional wireline payphone through a wireline telephone line, the device operating to interface payphone user telephone communications between a wireless cellular air interface and the wireline telephone line.

2. The wireless payphone as in claim 1 wherein the wireless interface device comprises one of a single line terminal (SLT) interface and fixed cellular terminal (FCT) interface.

3. The wireless payphone as in claim 1 wherein the wireless interface devices comprises a multi line terminal (MLT) interface.

4. The wireless payphone as in claim 1 wherein the wireline telephone line comprises an analog twisted pair telephone line.

5. The wireless payphone as in claim 1 wherein the wireline telephone line comprises a digital subscriber line telephone line.

6. The wireless payphone as in claim 1 wherein the wireless cellular air interface comprises an analog air interface.

7. The wireless payphone as in claim 1 wherein the wireless cellular air interface comprises a digital air interface.

8. The wireless payphone as in claim 1 wherein the wireless interface device is programmed to act, responsive to the wireline payphone going off-hook, by dialing a preprogrammed telephone number recognized in a serving wireless communications network to trigger serving network operation to calculate a permitted duration for user communications effectuated through that wireline payphone.

9. A wireless payphone system, comprising:
a wireless payphone device operable to transceive user communications over a wireless cellular air interface; and
a supporting cellular communications network including means within the network for calculating a permitted duration for user communications effectuated through the wireless payphone device and monitoring a call connection to ensure the call does not exceed the calculated permitted duration.

10. The wireless payphone system as in claim 9 wherein the supporting cellular communications network comprises:
a base transceiver station for communicating with the wireless payphone device over the wireless cellular air interface; and
a switching node connected to the base transceiver station and the means for calculating a permitted duration.

11. The wireless payphone system as in claim 10 wherein the switching node operates to trigger, responsive to wireless payphone dialing of a certain subscription telephone number other than a destination telephone number for a payphone call, an operation within the supporting cellular communications network to calculate the permitted use time for user communications effectuated through that wireline payphone device.

12. The wireless payphone system as in claim 10 further including means within the supporting cellular communications network f or collecting call payment information from the wireline payphone device user.

13. The wireless payphone system as in claim 12 wherein the means for collecting comprises an interactive voice response system activated responsive to the wireless payphone device going off-hook and operating to query the user for the call payment information.

14. The wireless payphone system as in claim 12 wherein the means for calculating determines the permitted use time based on the collected call payment information.

15. The wireless payphone system as in claim 9 wherein the wireless payphone device comprises:
a conventional wireline payphone; and
a wireless interface device connected to the conventional wireline payphone through a wireline telephone line, the device operating to interface payphone user telephone communications between the wireless cellular air interface and the wireline telephone line.

16. The wireless payphone system as in claim 15 wherein the wireless interface device comprises one of a single line terminal (SLT) interface and a fixed cellular terminal interface (FCT).

17. The wireless payphone system as in claim 15 wherein the wireless interface devices comprises a multi line terminal (MLT) interface.

18. The wireless payphone system as in claim 15 wherein the wireline telephone line comprises an analog twisted pair telephone line.

19. The wireless payphone system as in claim 15 wherein the wireline telephone line comprises a digital subscriber line telephone line.

20. The wireless payphone system as in claim 15 wherein the wireless cellular air interface comprises an analog air interface.

21. The wireless payphone system as in claim 15 wherein the wireless cellular air interface comprises a digital air interface.

22. A method, comprising the steps of:
responding to a received call origination dialed by a wireless cellular payphone to a certain telephone number recognized in a supporting cellular communications network as being associated with a payphone subscription by triggering supporting cellular network calculation of a permitted use time for user communications effectuated through that wireless cellular payphone;
through connecting the wireless cellular payphone to a user called destination to establish a call connection; and
monitoring a duration of the established call connection against the calculated permitted use time.

23. The method as in claim 22 further including the steps of:
detecting that the monitored duration has as least met the calculated permitted use time;
terminating the established call connection; and
charging a fee for the utilized permitted use time.

24. The method as in claim 23 further including the steps of:
determining prior to the step of through connecting a method of payment for the call; and
applying the fee against the determined method of payment.

25. The method as in claim 22 further including the steps of:
detecting a user termination of the established call connection prior to the expiration of the permitted use time;
calculating an elapsed use time; and
charging a fee for the calculated elapsed use time.

26. The method as in claim 25 further including the steps of:
determining prior to the step of through connecting a method of payment for the call; and
applying the fee against the determined method of payment.

27. A method, comprising the steps of:
receiving a call origination from a wireless payphone, the call origination dialed to a first telephone number associated with a wireless payphone subscription;
triggering at a serving mobile switching center responsive to the received call origination and the dialed first telephone number the execution of an incoming message coordination feature;
collecting within the execution of the incoming message coordination feature a second telephone number identifying a called party and information concerning a method of payment for the call;
determining within a payment system of the supporting cellular network the calculation of a permitted use time for user communications effectuated through the wireless payphone and with the called party;
sending of a location request message including the first telephone number from the serving mobile switching center to a home location register that stores the wireless payphone subscription;
recognizing at the home location register that the location request message concerns a wireless payphone subscription and querying the payment system to retrieve the second telephone number and the permitted use time;
communicating the second telephone number and the permitted use time from the home location register to the serving mobile switching center;
through connecting the wireless payphone to the called party to establish a call connection; and
monitoring a duration of the established call connection against the calculated permitted use time.

28. The method as in claim 27 further including the steps of:
detecting that the monitored duration has as least met the calculated permitted use time;
terminating the established call connection; and
charging a fee for the utilized permitted use time.

29. The method as in claim 28 further including the step of applying the fee against the identified method of payment.

30. The method as in claim 27 further including the steps of:
detecting a user termination of the established call connection prior to the expiration of the permitted use time;
calculating an elapsed use time; and
charging a fee for the calculated elapsed use time.

31. The method as in claim 30 further including the step of applying the fee against the identified method of payment.

32. A wireless cellular payphone system, comprising:
a mobile switching center serving a wireless cellular payphone, the mobile switching center receiving a call origination from a wireless payphone, wherein the call origination is dialed to a first telephone number associated with a wireless payphone subscription, and triggering the execution of an incoming message coordination feature;
an interactive voice response system connected to the mobile switching center and activated by the incoming message coordination feature to collect from the wireless cellular payphone a second telephone number identifying a called party and information concerning a method of payment for the call;
a payment system connected to the interactive voice response system and operable to calculate a permitted use time for user communications effectuated through the wireless payphone and with the called party; and
a home location register connected to the mobile switching center and the payment system and operating to store a subscription associated with the first telephone number;
wherein the mobile switching center pre-routes a call to the first telephone number to the home location register;
wherein the home location register recognizes that the pre-routing concerns the first telephone number subscription and queries the payment system to retrieve the second telephone number and the permitted use time for delivery to the mobile switching center; and
wherein the mobile switching center through connects the wireless payphone to the called party to establish a call connection, and monitors a duration of the established call connection against the calculated permitted use time.

33. The system as in claim 32 wherein the mobile switching center further detects that the monitored duration has as least met the calculated permitted use time and terminates the established call connection.

34. The system as in claim 33 wherein the payment system charges a fee for the utilized permitted use time against the identified method of payment.

35. The system as in claim 32 wherein the mobile switching center further detects a user termination of the established call connection prior to the expiration of the permitted use time and calculates an elapsed use time.

36. The system as in claim 35 wherein the payment system charges a fee for the calculated elapsed use time against the identified method of payment.
